(19) United States
(12) Patent Application Publication
(10) Pub. No.: US 2003/0061494 A1
(43) Pub. Date: Mar. 27, 2003

(54) Method and system for protecting data on a pc platform using bulk non-volatile storage

(76) Inventors: Luke E. Girard, Santa Clara, CA (US); David W. Grawrock, Aloha, OR (US)

Correspondence Address: PILLSBURY WINTHROP, LLP, P.O. BOX 10500, MCLEAN, VA, 22102, US

(21) Appl. No.: 09/962,862

(22) Filed: Sep. 26, 2001

(51) Int. Cl. H04L 9/00

(52) U.S. Cl. 713/189

(57) ABSTRACT

A method and system for protecting data on a computer is presented. A computer is provided that has a pre-operating system (pre-OS) space and an operating system-present (OS-present) space. Protected storage is accessed from pre-OS space via a trusted platform module (TPM). Similarly, protected storage is accessed from OS-present space via the TPM. As such, from both pre-OS space and OS-present space, a computer may prevent unauthorized users from gaining access to data stored in protected storage.

### BACKGROUND

1. Field

This invention relates in general to protected storage architectures. More specifically, this invention relates to a method and system for protecting data on a personal computer (PC) platform using bulk non-volatile storage.

2. General Background and Related Art

Personal computers (PCs) have become indispensable to modem societies. However, associated security concerns remain. Although it is essential that unauthorized users not be able to gain access to information stored on PCs, such users have found ways to circumvent conventional security measures, such as passwords and locks.

In a PC environment, two distinct environments exist. First, before a PC boots to an operating system, a pre-operating system (pre-OS) environment, or space, is present. Second, after the PC boots to an operating system, an OS-present space is operative. Architectures have been developed recently to reduce the vulnerability of PCs to attack from the respective spaces.

Relative to pre-OS space, the Intel Protected Access Architecture (IPAA) helps reduce PC theft by strengthening user authentication during the PC boot process. The IPAA architecture, see, e.g., Intel Protected Access Architecture, Application Interface Specification, Revision 1.0, defines a high-level programming interface to authentication devices and protected storage, as well as common interface elements needed to support the high-level interface. Protected storage is non-volatile storage subject to some kind of access control. Access control determines which entities have permission to read, write, modify, or update information contained within the protected storage.

FIG. 1 (Prior Art) illustrates a logical architecture of IPAA. Data is stored in fixed size chunks or slots 140. The size of slots 140 may vary depending on a particular implementation. Headers 150 are associated with slots 140 and contain access control information 130 (agents) and permissions 135 (rights). Access control information 130 is used to determine if a requester is authorized to gain access to data in a given slot 140. Permissions 135 determine which, if any, actions the requester is allowed to take on a given slot 140, such as read, write, or erase.

An access control engine 120 uses the information in headers 150 and information provided by the requestor to determine whether to complete a requested action, such as return slot data, erase slot data, or change password. The IPAA architecture also provides a global access control object for administration 160 and one or more slot-oriented access control objects for permissions 165, thereby affording different entities access to the same physical data with associated permissions. Access control engine 120 also implements security protocols prescribed by a given implementation, such as challenge/response or rolling nonce. A protected storage interface 101 links a pre-OS application or applet to access control engine 120.

System FLASH in a PC typically may serve as protected storage by using read/write capabilities of pre-OS space. However, such protected storage is only available to pre-OS applications. When system FLASH is used in OS-present space, stored data is vulnerable to software attack.

Relative to OS-present space, the Trusted Computing Platform Alliance (TCPA) has defined an architecture that improves the basis on which a computing environment may be trusted. FIG. 2 (Prior Art) illustrates a logical architecture of TCPA, see, e.g., TCPA Specification v. 1.0. TCPA-protected storage is provided by a register or group of registers 230 that are intended for non-typed data. An access control engine 210 controls access to registers 230 based on user administration credentials 220. Further, an interface 201 interfaces OS-present applications with access control engine 210.

The TCPA architecture includes an isolated computing engine, or trusted platform module (TPM) (not shown), whose processes can be trusted because they cannot be altered. Trusted processes provided by the TPM include protected storage, digital signature, and PKI (public key infrastructure) key support. Additionally, the TPM may encrypt or wrap data, such as a key, and may bind or seal an internally generated asymmetric key pair to a particular TPM and/or a particular platform configuration. However, the TCPA protected storage in registers 230 is very limited and awkward to use.

Therefore, what is needed is a method and system for protecting data on a PC platform using bulk non-volatile storage that is effective in both pre-OS space and OS-present space.

### BRIEF DESCRIPTION OF THE DRAWINGS

FIG. 1 (Prior Art) is a high-level diagram of an IPAA architecture.

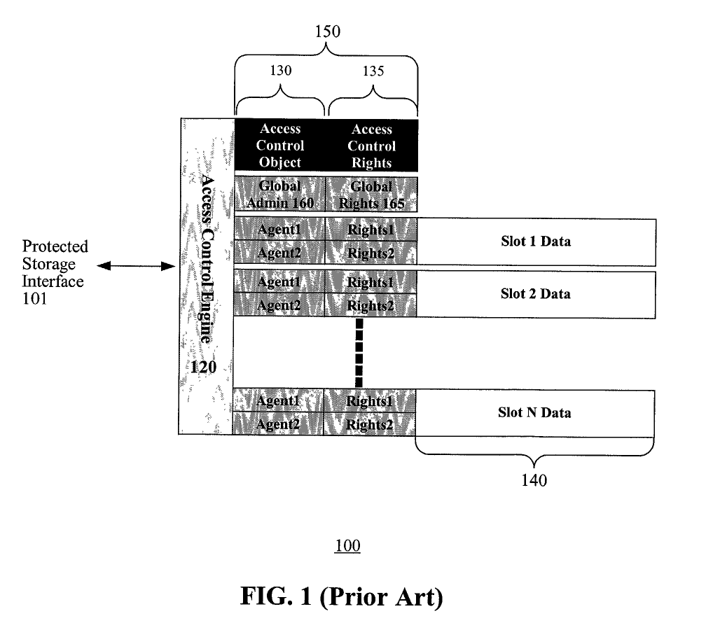

FIG. 2 (Prior Art) is a high-level diagram of a TCPA architecture.

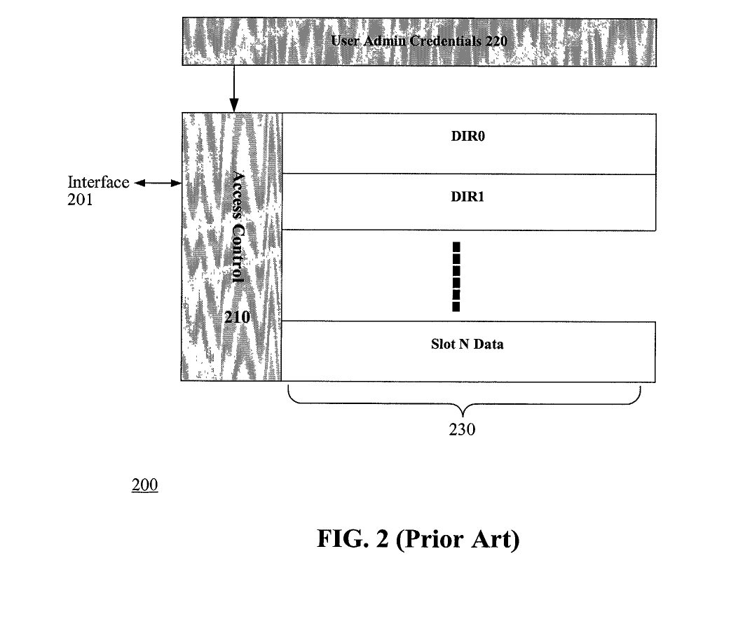

FIG. 3 is a high-level diagram of an architecture according to an embodiment of the present invention.

FIG. 4 is a high-level diagram of an architecture according to an embodiment of the present invention.

FIG. 5 is a high-level flow diagram of a method according to an embodiment of the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A method and system for protecting data on a computer, as presented herein, involves a computer that has a pre-operating system (pre-OS) space and an operating system-present (OS-present) space. Protected storage is accessed from pre-OS space via a trusted platform module (TPM). Similarly, protected storage is accessed from OS-present space via the TPM. As such, from both pre-OS space and OS-present space, the computer is secure, preventing unauthorized users from gaining access to information stored in protected storage.

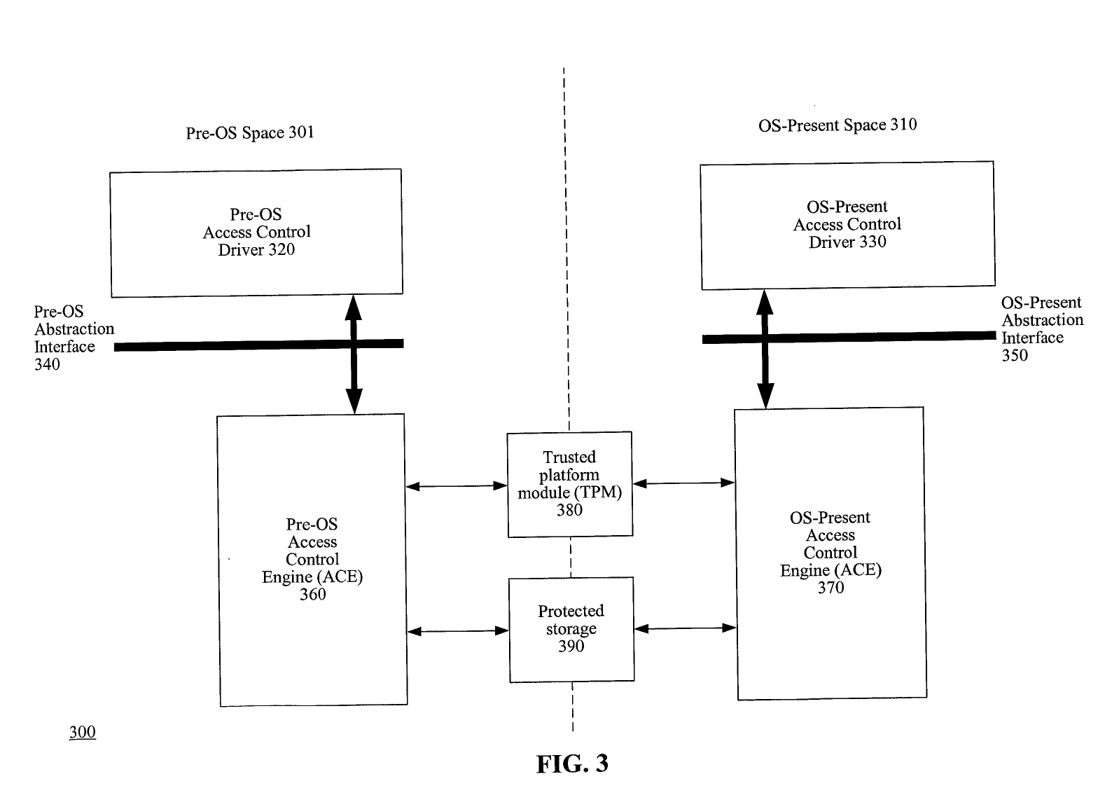

FIG. 3 illustrates a computer architecture 300 according to an embodiment of the present invention. A computer whose architecture is consistent with architecture 300 may comprise any kind of computer, such as, for example, a personal computer, a client, a server, a desktop computer, or a laptop. Architecture 300 functions in pre-OS space 301 and OS-present space 310. Pre-OS space 301 includes a pre-OS access control driver 320, a pre-OS abstraction interface 340, and a pre-OS access control engine (ACE) 360.

OS-present space 310 includes an OS-present access control driver 330, an OS-present abstraction interface 350, and an OS-present access control engine (ACE) 370.

Pre-OS ACE 360 and OS-present ACE 370 both may access protected storage 390 and a TPM 380.

Protected storage 390 may include a non-volatile memory within a computer. Protected storage 390 may comprise, for example, FLASH memory, a variant thereof, such as the 82802 Firmware Hub (FWH) offered by Intel Corporation, or electrically erasable programmable read-only memory (EEPROM).

TPM 380 may include a module that has various processing facilities, such as key generation, data wrapping (encrypting), and binding and sealing capabilities. TPM 380 may be implemented in hardware, firmware, software, or a combination thereof. In an exemplary implementation, TPM 380 conforms to a specification of the TCPA. As such, TPM 380 may store wrapped data, such as keys, in various non-volatile locations on a platform, such as protected storage 390. Similarly, other modules in architecture 300 may conform to a TCPA specification, an IPAA specification, or both specifications. However, it is not necessary that architecture 300 be implemented according to such specifications. Other specifications that include various modules of architecture 300 may be suitable for implementation according to the present invention.

Pre-OS access control driver 320 services requests originating in pre-OS space 301. Specifically, pre-OS access control driver 320 may act as a master control for preboot user authentication. Pre-OS access control driver 320 may comprise an applet programmed in the BIOS (basic input/output system) of a computer which executes during boot-up of the computer. OS-present access control driver 330 services requests originating in OS-present space 310. For example, OS-present access control driver 330 may comprise a driver running in the Windows NT operating system. Pre-OS access control driver 320 and OS-present access control driver 330 enable the sending of information to respective ACEs 360, 370 and the receiving of information therefrom.

Pre-OS abstraction interface 340 is a logical interface between pre-OS access control driver 320 and pre-OS ACE 360. Similarly, OS-present abstraction interface 350 is a logical interface between OS-present access control driver 330 and OS-present ACE 370. Abstraction interfaces 340, 350 may define, for example, function names, calling convention, return convention, and buffer structures. Abstraction interfaces 340, 350 may define a minimal subset of high-level function calls needed for user authentication and storage.

Pre-OS ACE 360 and OS-present ACE 370 control access to protected storage 390 and control TPM 380. OS ACE 360 and OS-present ACE 370 provide device-specific support for TPM 380 and protected storage 390. ACE 360, 370 may initialize structures of protected storage 390 and manage logical and electrical details of protected storage 390. Accordingly, protected storage 390 may be made available to both pre-OS and OS-present applications. In an exemplary implementation, pre-OS ACE 360 corresponds to a pre-OS storage service provider as set forth in an IPAA specification. Further, OS-present ACE 370 corresponds to an OS-present protected storage driver as set forth in a TCPA specification. ACE 360, 370 may be respectively implemented in software, hardware, or a combination thereof.

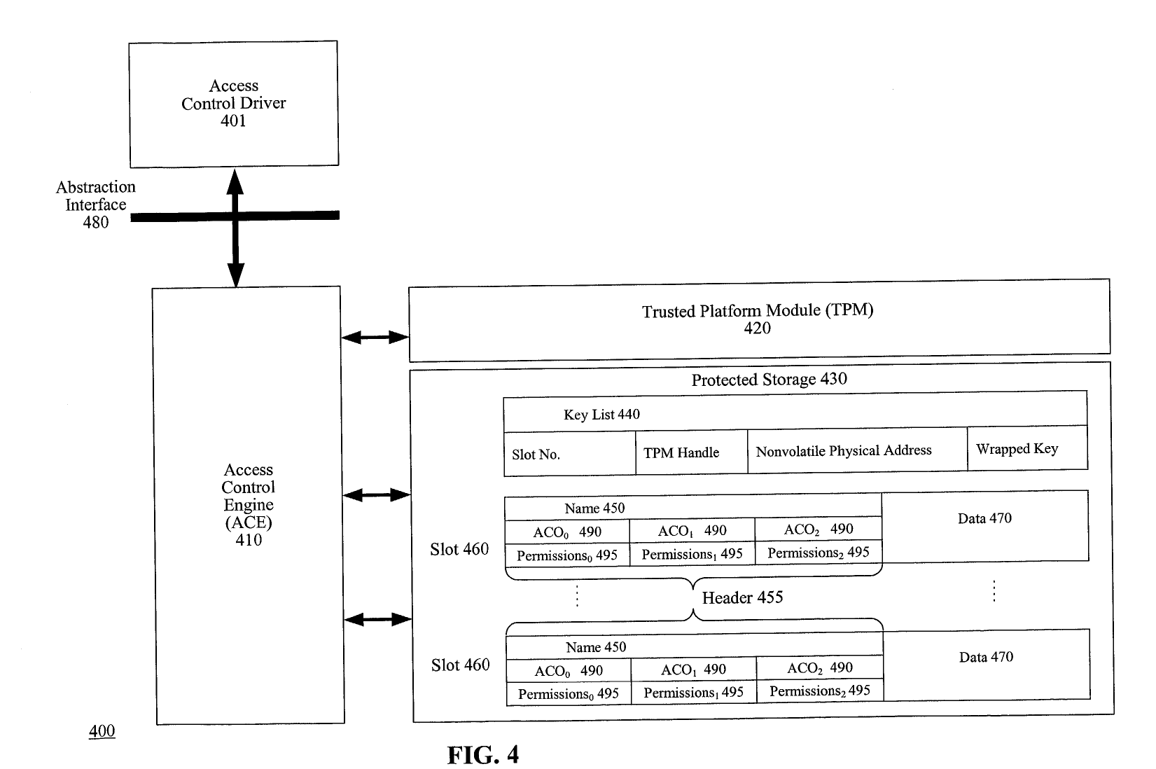

FIG. 4 illustrates computer architecture 400 according to an embodiment of the present invention. Architecture 400 includes an access control driver 401, an abstraction interface 480, an access control engine (ACE) 410, a trusted platform module (TPM) 420, and protected storage 430. Access control driver 401 and ACE 410 may comprise distinct pre-OS and OS-present components, such as those shown in FIG. 3. Components of architecture 400 may be implemented in hardware, firmware, software, or combinations thereof as described above. ACE 410 is configured to provide at least the functions described with respect to ACE 360, 370 above.

In an exemplary implementation, ACE 410 manages sections of protected storage 430 as platform non-volatile protected storage. Protected storage 430 may include various slots 460. The number and size of slots 460 may vary across specific implementations. Each slot 460 may include a header 455 and data 470. Header 455 may include a name field 450, one or more access control object (ACO) fields 490, and one or more permissions fields 495. Data 470 may be encrypted and thus opaque from the vantage point of unauthorized users.

Name field 450 identifies an access control protocol, such as challenge/response or rolling nonce, that has been applied to protect against tampering of data 470 in slot 460. Each permissions field 495 defines types of actions that may be taken with respect to data 470 in the associated slot 460. Exemplary permissions include read, write, and free (only free slots can be erased).

Each permissions field 495 may be associated with an ACO field 490. An ACO is associated with a specific entity. As such, a pair consisting of an ACO field 490 and a permissions field 495 prescribes actions which an entity may take with respect to data 470. As shown in FIG. 4, slots 460 in protected storage 430 include multiple pairs of ACO fields 490 and permissions fields 495. The inclusion of multiple ACO fields 490 in a slot 460 provides more secure control over data 470 because, for example, the entities that have permission to write data into slot 460 can be different from those that can read data therefrom.

In another embodiment of the present invention, each name field 450 and permissions field 495 may be stored as plaintext. In specifications such as IPAA, an access control protocol is specified by name during an enumeration process so that required protocols can be communicated to endpoints such as access control driver 401 or ACE 410. The use of plaintext may facilitate this enumeration process.

To ensure that protected storage 430 is accessible in pre-OS and OS-present space, protected storage 430 may be left unlocked. As such, data 470 in each slot 460 may be encrypted by an application program that uses data 470. In particular, in a TCPA implementation, the Trusted Platform Subsystem (TPS), which includes a TPM, may provide bulk encryption services.

Each ACO field 490 may be encrypted to provide increased security in architecture 400. TPM 420 may be configured to generate an asymmetric key pair, as well as to bind or seal such a key pair to a particular platform configuration. Where storage is bound to a platform, only the associated platform may use such storage. Alternatively, architecture 400 may include a module or modules (not shown) that perform such functions on behalf of TPM 420. In an exemplary TCPA implementation, ACE 410 may employ TPM 420 to assign a unique asymmetric key pair to an ACO field 490 and use a key of the key pair to encrypt or wrap an ACO before it is placed into the ACO field 490. Such an approach may provide flexibility in governing how an ACO is used and managed.

In another embodiment, separate ACO fields 490 may be set up that are only usable in certain contexts or operating environments, such as pre-OS only, OS-present only, remote boot only, and combinations thereof. Accordingly, ACE 410 may maintain a key list 440 in protected storage 430 that associates key pairs with slots 460 and/or ACO fields 490 within slots 460. Key list 440 may include various data, such as slot number, TPM handle, non-volatile physical address, and wrapped key. It is to be noted that an entire slot 460 may be encrypted when a key list 440 is included in protected storage 430.

In other implementations, a subfield within an ACO field 490 may be maintained instead of a separate key list 440. The subfield may contain one or more wrapped signature keys. The pre-OS and OS-present components of ACE 410 may be configured appropriately to support this arrangement.

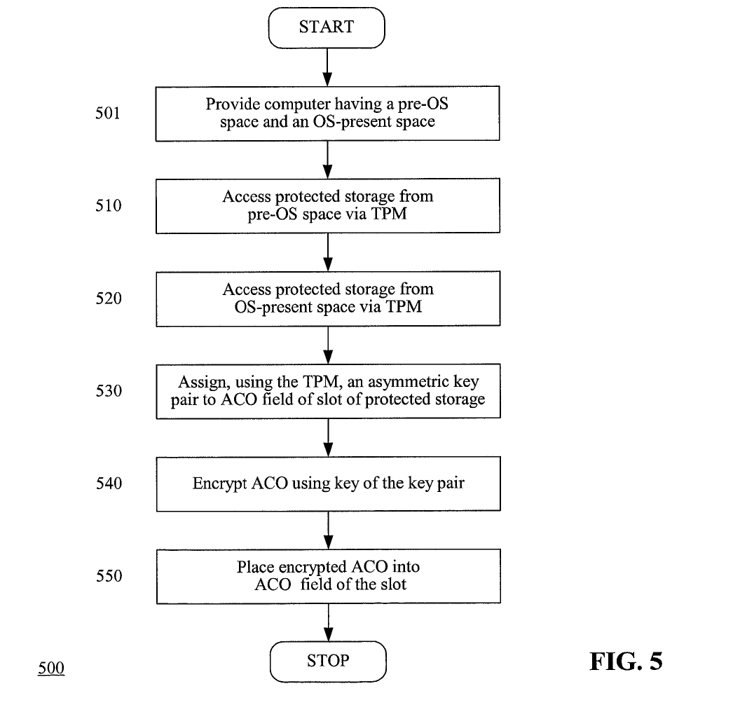

FIG. 5 is a high-level flow diagram of method 500 according to an embodiment of the present invention. In item 501, a computer is provided that has a pre-OS space and an OS-present space. Protected storage in the computer is accessed from pre-OS space via a TPM in item 510. In item 520, protected storage is accessed from OS-present space via the TPM. In item 530, an asymmetric key pair is assigned to an ACO field of a slot of the protected storage using the TPM. In item 540, the ACO is encrypted using a key of the key pair. In item 550, the encrypted ACO is placed into the ACO field of the slot.

The foregoing description of the preferred embodiments is provided to enable any person skilled in the art to make or use the present invention. Various modifications to these embodiments are possible, and the generic principles presented herein may be applied to other embodiments as well. For example, protected storage may comprise multiple non-volatile memories that are addressed by an access control engine.

Further, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for protecting data on a computer having a pre-operating system (pre-OS) space and an operating system-present (OS-present) space, the method comprising:
accessing, from pre-OS space via a trusted platform module (TPM), protected storage; and
accessing, from OS-present space via the TPM, protected storage.

2. The method of claim 1, wherein the computer conforms to a Trusted Computing Platform Alliance (TCPA) specification and an Intel Protected Access Architecture (IPAA) specification.

3. The method of claim 1, wherein the protected storage comprises non-volatile storage.

4. The method of claim 3, wherein the protected storage comprises FLASH memory.

5. The method of claim 1, wherein the accessing protected storage from pre-OS space includes sending and receiving information via an access control driver.

6. The method of claim 1, wherein the accessing protected storage from OS-present space includes sending and receiving information via an access control driver.

7. The method of claim 1, further comprising encrypting data for storage in a slot of the protected storage.

8. The method of claim 7, wherein an application program encrypts the data.

9. The method of claim 1, further comprising:
assigning an asymmetric key pair to an access control object (ACO) field of a slot of the protected storage;
encrypting, using a key of the key pair, an ACO; and
placing the encrypted ACO into the ACO field of the slot.

10. The method of claim 1, further comprising storing, as plaintext, data within a name or permissions field of a slot of the protected storage.

11. A computer for protecting data, comprising:
protected storage;
a trusted platform module (TPM) configured to access the protected storage;
a first access control engine (ACE) for pre-operating system (pre-OS) space, the first ACE being configured to control access to the protected storage and to control the TPM; and
a second ACE for operating system-present (OS-present) space, the second ACE being configured to control access to the protected storage and to control the TPM.

12. The computer of claim 11, wherein the computer is configured to conform to a Trusted Computing Platform Alliance (TCPA) specification and an Intel Protected Access Architecture (IPAA) specification.

13. The computer of claim 11, wherein the protected storage comprises non-volatile storage.

14. The computer of claim 13, wherein the protected storage comprises FLASH memory.

15. The computer of claim 11, further comprising an access control driver configured to enable the sending and receiving of information from one of pre-OS and OS-present space.

16. The computer of claim 11, wherein data in a slot of the protected storage is encrypted.

17. The computer of claim 16, wherein the data is encrypted by an application program.

18. The computer of claim 11, wherein an asymmetric key pair is assigned to an access control object (ACO) field of a slot of the protected storage, an ACO is encrypted using a key of the key pair, and the encrypted ACO is placed into the ACO field of the slot.

19. The computer of claim 11, wherein data within a name or permissions field of a slot of the protected storage is stored as plaintext.

20. The computer of claim 11, wherein the first ACE or the second ACE is configured to manage at least one portion of the protected storage.

21. The computer of claim 11, wherein the first ACE is implemented in pre-OS space and the second ACE is implemented in OS-present space.

22. The computer of claim 11, wherein the protected storage includes a plurality of access control object (ACO) fields and a plurality of permissions fields, each among the plurality of ACO fields being associated with a respective one among the plurality of permissions fields.

23. The computer of claim 22, wherein an ACO field is associated with a predetermined operating environment.

24. The computer of claim 11, wherein the first ACE or the second ACE is configured to associate at least one asymmetric key pair to one of a slot within the protected storage and an access control object (ACO) field.

25. The computer of claim 11, wherein the TPM is configured to at least wrap a key.

26. An article of manufacture comprising:
a machine-accessible medium comprising data that cause a machine to,
access protected storage from pre-operating system (pre-OS) space of a computer, via a trusted platform module (TPM); and
access protected storage from operating system-present (OS-present) space of the computer, via the TPM.

27. The article of manufacture of claim 26, wherein the protected storage comprises non-volatile storage.

28. The article of manufacture of claim 26, wherein accessing protected storage from pre-OS space includes sending and receiving information via an access control driver.

29. The article of manufacture of claim 26, wherein the machine-accessible medium further comprises data that cause the machine to encrypt data for storage in a slot of the protected storage.

30. The article of manufacture of claim 29, wherein the machine-accessible medium further comprises data that cause the machine to:
assign an asymmetric key pair to an access control object (ACO) field of a slot of the protected storage;
encrypt, using a key of the key pair, an ACO; and
place the encrypted ACO into the ACO field of the slot.
